(19) United States
(12) Patent Application Publication
(10) Pub. No.: US 2005/0183756 A1
(43) Pub. Date: Aug. 25, 2005

(54) Car wash with variable entrance/exit orientation

(76) Inventor: I-Liang Fang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/782,905

(22) Filed: Feb. 23, 2004

(51) Int. Cl. B08B 3/02

(52) U.S. Cl. 134/123; 134/148; 134/157; 134/181

(57) ABSTRACT

A car wash includes a supporting mechanism and a washing mechanism. The supporting mechanism includes a fixed base and a supporting disc rotatably mounted to the fixed base. The supporting disc can be stopped in any orientation relative to the fixed base, providing an orientation-variable entrance/exit. The supporting disc includes a top side for supporting a car to be washed by the washing mechanism.

### BACKGROUND OF THE INVENTION

1. Field of the Invention

The present invention relates to a car wash that has a variable entrance orientation and a variable exit orientation.

2. Description of the Related Art

A typical car wash has a fixed entrance and a fixed exit, allowing a car to enter via the entrance and to leave via the exit. The car is moved and washed along a fixed line between the entrance and the exit. Use of the space is limited, and the time for washing the car could not be shortened. The present invention is intended to provide a car wash that mitigates and/or obviates these problems.

### SUMMARY OF THE INVENTION

In accordance with an aspect of the present invention, a car wash includes a supporting mechanism and a washing mechanism. The supporting mechanism includes a fixed base and a supporting disc rotatably mounted to the fixed base. The supporting disc can be stopped in any orientation relative to the fixed base, providing an orientation-variable entrance/exit. The supporting disc includes a top side for supporting a car to be washed by the washing mechanism.

In an embodiment of the invention, the supporting disc includes an axle on an underside thereof, and the fixed base includes an axle seat for rotatably receiving the axle. The supporting disc includes a ring on an underside thereof A plurality of teeth are defined in an inner periphery of the ring. A drive gear driven by, e.g., a step motor, is mounted in the fixed base and meshes with the teeth of the ring. A plurality of rollers are provided on the underside of the supporting disc, and the fixed base includes an annular track along which the rollers move.

Other objects, advantages, and novel features of the invention will become more apparent from the following detailed description when taken in conjunction with the accompanying drawings.

### BRIEF DESCRIPTION OF THE DRAWINGS

FIG. 1 is a schematic sectional view of a car wash in accordance with the present invention.

FIG. 2 is an exploded perspective view of a supporting mechanism of the car wash in accordance with the present invention.

FIG. 3 is a top view of the supporting mechanism in accordance with the present invention.

FIG. 4 is a sectional view similar to FIG. 1, illustrating car washing operation.

FIG. 5 is a sectional view similar to FIG. 1, wherein the car is entering or leaving the car wash.

FIG. 6 is a top view of the car wash, wherein a car is in a position for car washing operation.

FIG. 7 is a top view similar to FIG. 6, wherein the car is leaving the car wash.

### DETAILED DESCRIPTION OF THE PREFERRED EMBODIMENT

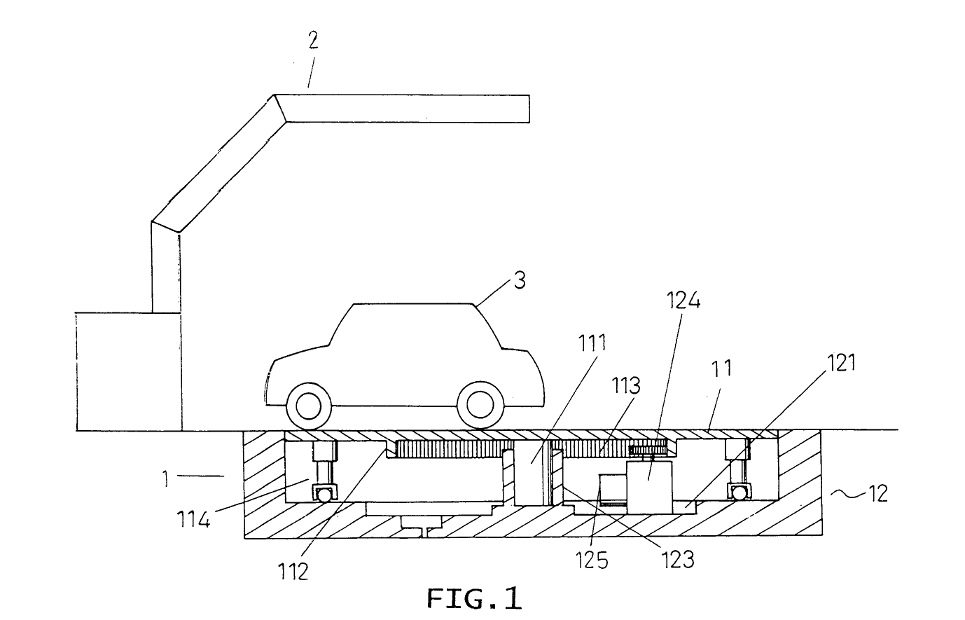

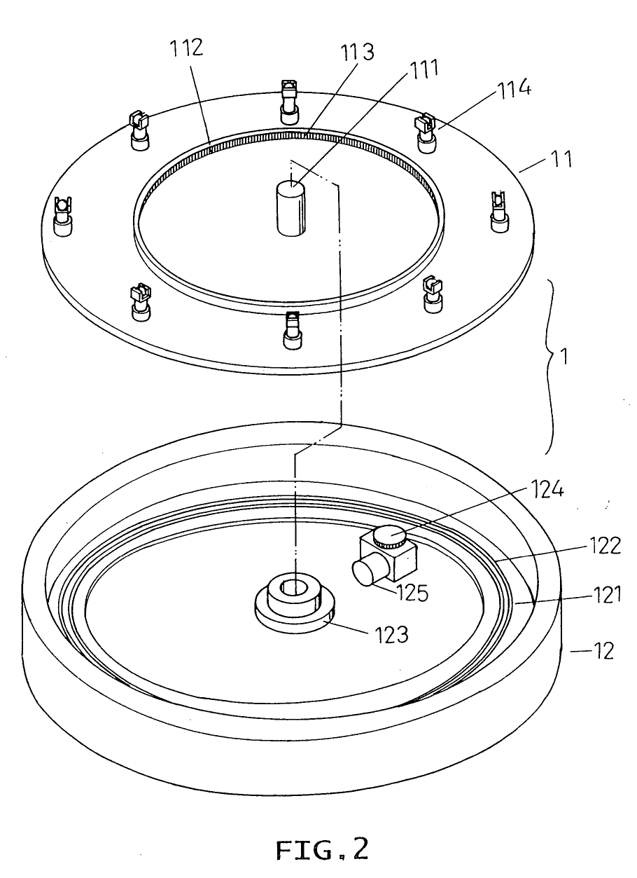

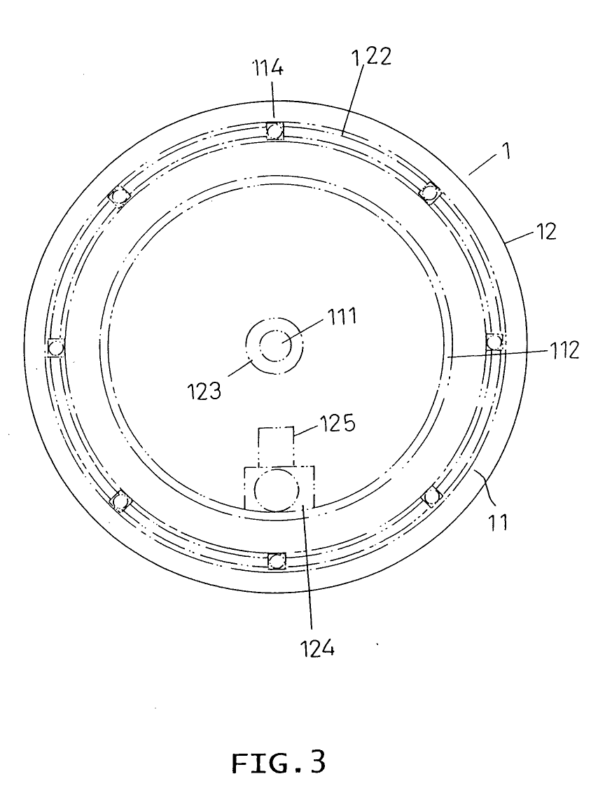

Referring to FIG. 1, a car wash in accordance with the present invention generally comprises a supporting mechanism 1 and a washing mechanism 2. As illustrated in FIGS. 2 and 3, the supporting mechanism 1 includes a fixed base 12 and a supporting disc 11 rotatably mounted to the fixed base 12. In this embodiment, the supporting disc 11 includes an axle 111 on a center of an underside thereof Further, a ring 112 is formed on the underside of the supporting disc 11, with the axle 111 being located in a center of the ring 112, and with a plurality of teeth 113 being defined in an inner periphery of the ring 112. Further, a plurality of annularly spaced guides 114 (preferably rollers) are provided on the underside of the supporting disc 11 and around the ring 112.

The fixed base 12 may be mounted in a pit (not labeled) in the ground and include an axle seat 123 in a central portion thereof for rotatably receiving the axle 111 of the supporting disc 11. Further, the fixed base 12 includes a stepped portion 121 defining an annular track 122 along which the guides 114 of the supporting disc 11 move. A drive gear 124 is mounted in the fixed base 12 and meshes with the teeth 113 of the ring 112. The drive gear 124 can be driven by, e.g., a step motor 125 to thereby turn the supporting disc 11.

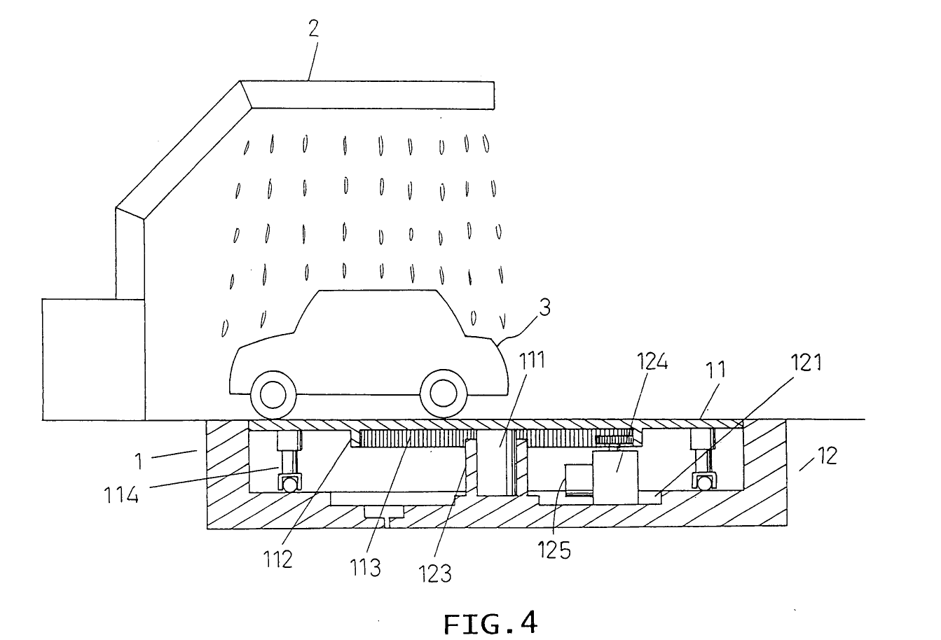

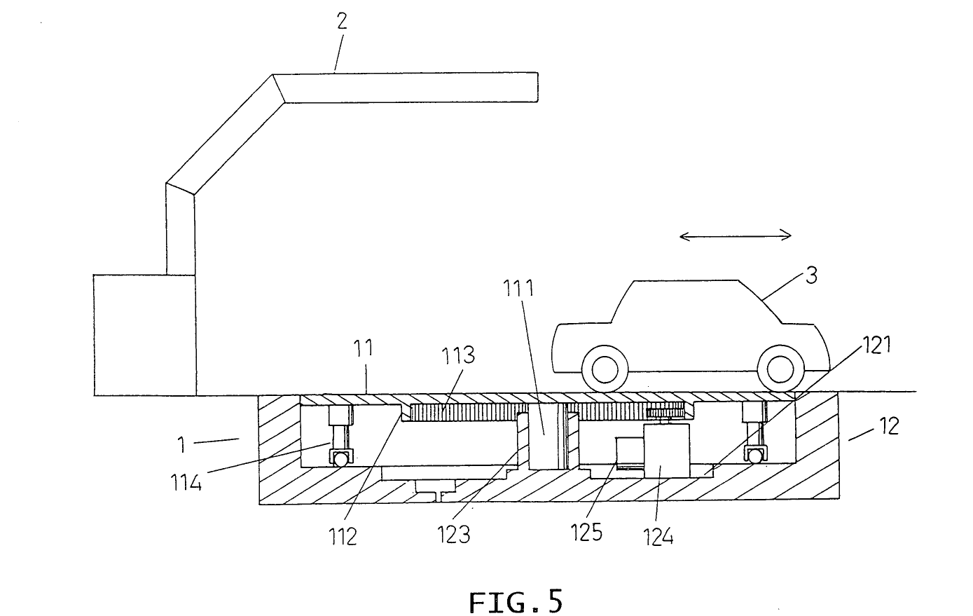

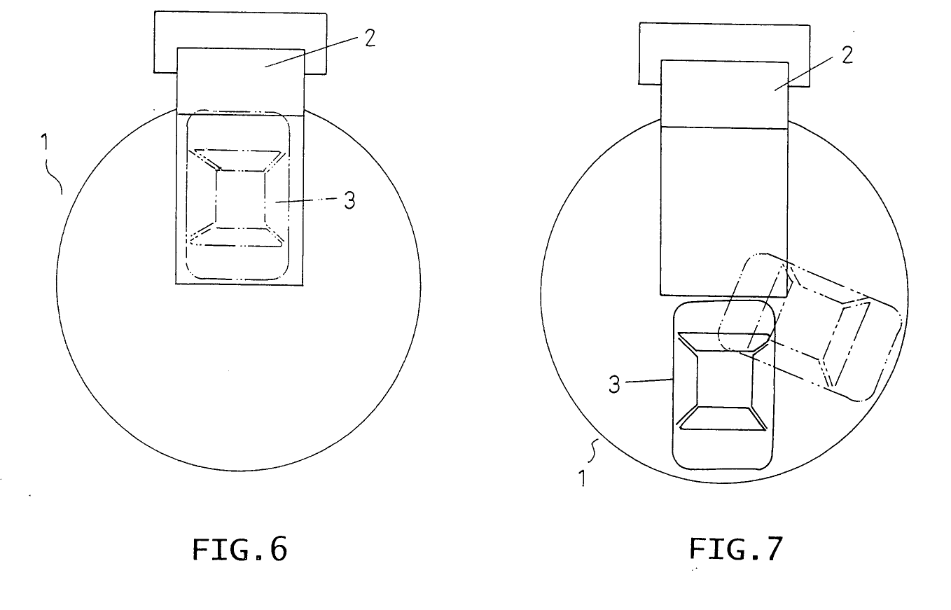

Referring to FIGS. 4 and 6, a top side of the supporting disc 11 provides a support for a car during the car washing operation carried out by the washing mechanism 2. As shown in FIGS. 5 and 7, the car may enter the car wash before the car washing operation in any orientation and leave the car wash after the car washing operation in any orientation, as the supporting disc 11 can be stopped by the step motor 125 in any orientation relative to the fixed base 12.

Installation of the car wash in accordance with the present invention can be rapidly completed, and the time for installation can be reduced by half The top side of the supporting disc 11 is exposed and thus allows easy maintenance. Further, the top side of the top side of the supporting disc 11 can be used for other purposes when the car wash is not in use. The car may enter/leave the car wash in any orientation, providing flexibility to installation of the car wash. Further, the time for washing the car (including the time of entering and leaving the car wash) is shortened.

Although the invention has been explained in relation to its preferred embodiment, it is to be understood that many other possible modifications and variations can be made without departing from the scope of the invention as hereinafter claimed.

1. A car wash comprising:
a supporting mechanism including a fixed base and a supporting disc rotatably mounted to the fixed base, the supporting disc being stoppable in any orientation relative to the fixed base, the supporting disc including a top side for supporting a car to be washed; and
a washing mechanism for washing the car supported on the supporting disc.

2. The car wash as claimed in claim 1, wherein the supporting disc includes an axle on an underside thereof, the fixed base including an axle seat for rotatably receiving the axle.

3. The car wash as claimed in claim 1, wherein the supporting disc includes a ring on an underside thereof, a plurality of teeth being defined in an inner periphery of the ring, a drive gear being mounted in the fixed base and meshing with the teeth of the ring.

4. The car wash as claimed in claim 1, wherein the supporting disc includes a plurality of guides on an underside thereof, the fixed base including an annular track along which the guides move.

5. The car wash as claimed in claim 2, wherein the supporting disc includes a ring on the underside thereof, a plurality of teeth being defined in an inner periphery of the ring, a drive gear being mounted in the fixed base and meshing with the teeth of the ring.

6. The car wash as claimed in claim 2, wherein the supporting disc includes a plurality of guides on the underside thereof, the fixed base including an annular track along which the guides move.

7. The car wash as claimed in claim 3, further including a step motor for driving the drive gear.

8. The car wash as claimed in claim 5, further including a step motor for driving the drive gear.
